(19) United States
(12) Patent Application Publication
(10) Pub. No.: US 2025/0336961 A1
(43) Pub. Date: Oct. 30, 2025

(54) ELECTROLYTE-FREE LIxSI/SI ANODE ELECTRODE FOR ALL-SOLID-STATE BATTERY CELL

(71) Applicant: GM GLOBAL TECHNOLOGY OPERATIONS LLC, Detroit, MI (US)

(72) Inventors: Qili SU, Shanghai (CN); Zhe LI, Shanghai (CN); Haijing LIU, Shanghai (CN)

(21) Appl. No.: 18/663,786

(22) Filed: May 14, 2024

(30) Foreign Application Priority Data
Apr. 26, 2024 (CN) 2024105168411

(51) Int. Cl. H01M 4/38; H01M 4/02; H01M 4/134; H01M 4/62; H01M 4/66; H01M 4/72

(52) U.S. Cl. CPC H01M 4/386; H01M 4/134; H01M 4/623; H01M 4/662; H01M 4/667; H01M 4/72; H01M 2004/021; H01M 2004/027

(57) ABSTRACT

A method for manufacturing a battery cell includes providing an anode active material layer including silicon particles and PTFE binder; and pressing the anode active material layer and an anode current collector together to form an anode electrode. The anode current collector comprises a composite material comprising a first material and lithium arranged on at least one side of the first material and in contact with the anode active material layer.

### CROSS-REFERENCE TO RELATED APPLICATIONS

This application claims the benefit of Chinese Patent Application No. 202410516841.1, filed on Apr. 26, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to an electrolyte-free, LiₓSi/Si anode electrode for an all-solid-state battery cell.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

A method for manufacturing a battery cell includes providing an anode active material layer including silicon particles and PTFE binder; and pressing the anode active material layer and an anode current collector together to form an anode electrode. The anode current collector comprises a composite material comprising a first material and lithium arranged on at least one side of the first material and in contact with the anode active material layer.

In other features, the first material is selected from a group consisting of copper, stainless steel, and titanium. The lithium that is formed on the at least one side of the anode current collector has the same dimensions as the first material. The composite material includes holes.

In other features, the lithium formed on the at least one side of the anode current collector includes a plurality of lithium portions that are spaced from one another. The plurality of lithium portions have a length and width corresponding to a length and width of the anode electrode. The lithium that is formed on the at least one side of the anode current collector includes a plurality of strips that are spaced from one another.

In other features, the anode active material layer includes the anode active material in a range from 95 wt % to 99.9 wt % and the binder in a range from 0.1 wt % to 5 wt %. A thickness of the anode electrode is in a range from 5 μm to 100 μm, a thickness of the lithium is in a range from 2 μm to 20 μm, and the silicon particles have a diameter in a range from 1 μm to 10 μm.

In other features, the PTFE binder has a particle size in a range from 100 μm to 800 μm, and a weight ratio of the PTFE binder to the anode electrode is in a range from 0.01:100 to 20:100.

An anode electrode for manufacturing a battery cell includes an anode active material layer including silicon particles and PTFE binder. An anode current collector comprises a composite material including a first material and lithium arranged on at least one side of the first material and in contact with the anode active material layer. The lithium reacts with the anode active material layer to form amorphous carbon, lithium fluoride, and LiₓSi in the active material layer prior to formation.

In other features, the first material is selected from a group consisting of copper, stainless steel, and titanium. The lithium arranged on the at least one side of the anode current collector has the same dimensions as the first material. The anode current collector includes holes. The lithium formed on the at least one side of the anode current collector includes a plurality of lithium portions that are spaced from one another. The plurality of lithium portions have a length and width corresponding to a length and width of the anode electrode. The lithium formed on the at least one side of the anode current collector includes a plurality of strips that are spaced from one another. The anode active material layer includes the anode active material in a range from 95 wt % to 99.9 wt % and the binder in a range from 0.1 wt % to 5 wt %.

In other features, a thickness of the anode electrode is in a range from 5 μm to 100 μm, a thickness of the lithium is in a range from 2 μm to 20 μm, and the silicon particles have a diameter in a range from 1 μm to 10 μm. The PTFE binder has a particle size in a range from 100 μm to 800 μm, and a weight ratio of the PTFE binder to the anode electrode is in a range from 0.01:100 to 20:100.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of an example of a battery cell including cathode electrodes, anode electrodes, and separators according to the present disclosure;

FIG. 2A is a side cross section of an example of an ideal anode electrode including an anode active material layer including silicon particles and a binder arranged on an anode current collector;

FIGS. 2B and 2C are side cross sections of the ideal anode electrode of FIG. 2A during charging and discharging, respectively;

FIG. 3A is a side cross section of an example of a practical anode electrode including an anode active material layer including silicon and a binder arranged on an anode current collector;

FIGS. 3B and 3C are side cross sections of the practical anode electrode of FIG. 2A during charging and discharging, respectively;

FIG. 4A to 5D are plan views of examples of composite anode current collectors according to the present disclosure;

FIG. 5A is a side view of an example of a roll-to-roll manufacturing process for an anode electrode according to the present disclosure;

FIG. 5B is a side cross section of an example of an anode active material layer before pressing with the anode current collector according to the present disclosure;

FIG. 5C is a side cross section of an example of an anode active material layer after pressing with the anode current collector according to the present disclosure;

FIG. 6A is a side view of an example of a flat pressing method for manufacturing an anode electrode according to the present disclosure;

FIG. 6B is a side cross section of an example of a dry silicon film before pressing with the anode current collector according to the present disclosure;

FIGS. 7A to 7C are side cross sections of an example of a battery cell including a cathode electrode, an anode electrode, and a separator according to the present disclosure;

FIGS. 8A and 8B are examples of scanning electron microscope images of the anode electrode according to the present disclosure;

FIG. 9 is a graph showing an example of voltage as a function of capacity (for a first cycle at 0.1 C and room temperature) for a battery cell with a conventional anode electrode and an electrolyte-free lithiated silicon anode electrode according to the present disclosure; and

FIG. 10 is a graph showing an example of capacity as a function of cycles (at room temperature) for a battery cell with a conventional anode electrode and an electrolyte-free, lithiated silicon anode electrode according to the present disclosure.

In the drawings, reference numbers may be reused to identify similar and/or identical elements.

### DETAILED DESCRIPTION

While the battery cells are described below in the context of vehicles, the battery cells can be used in other mobile or stationary applications.

All-solid-state battery (ASSB) cells including anode electrodes with dry silicon film as the active material have the potential for high energy density (>98 wt % active material). These anode electrodes can be electrolyte free or use less electrolyte at the silicon interface. Further, less control of the electrode fabrication environment is required. However, anode electrodes including silicon particles (99 wt %) mixed with a binder (e.g., PTFE at 1 wt %) have low coulombic efficiency and experience rapid active lithium loss.

The present disclosure relates to a battery cell including an anode electrode with a silicon-based anode active material layer (e.g., silicon particles) and a binder (e.g., PTFE) that are manufactured with excess active lithium to compensate for lithium loss that occurs within the anode active material layer (e.g., the dry silicon film) after formation.

Unless steps are taken, active lithium from the cathode electrode is consumed by the PTFE binder in a side reaction after formation: 2nLiₓSi+x[CF₂]ₙ=2nxLiF+nxC(amorphous). Since there is no electrolyte within the silicon anode electrode, active lithium is stored within the silicon particles as LiₓSi to transport lithium ions. Additional excess active lithium is needed to compensate for the lithium loss within the dry silicon film after formation.

A LiₓSi/Si anode electrode according to the present disclosure includes LiₓSi/Si active materials, amorphous carbon (C), and lithium fluoride (LiF). In some examples, the anode electrode is sulfide electrolyte-free. The anode electrode described herein enhances energy density at the electrode level, removes the electrolyte mixing process, reduces material cost, and/or reduces environmental complexity during manufacturing.

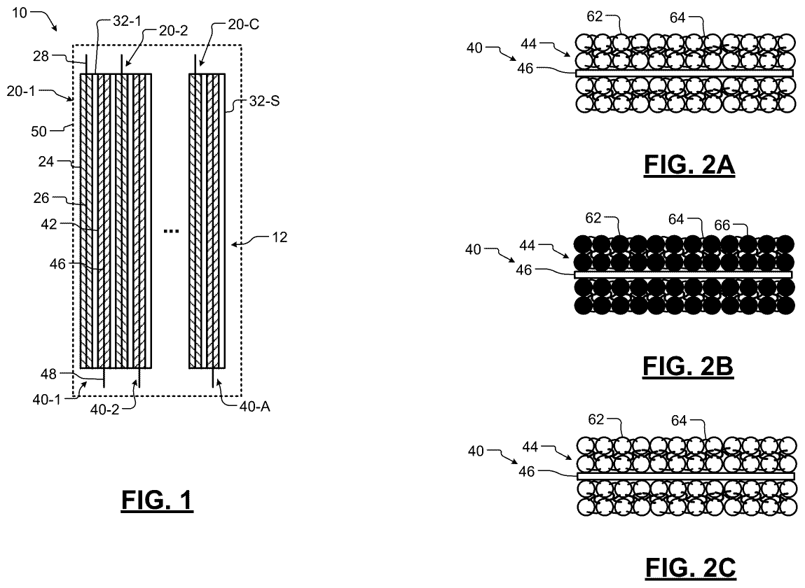

Referring now to FIG. 1, a battery cell 10 includes C cathode electrodes 20, A anode electrodes 40, and S separators 32 arranged in a predetermined sequence in a battery cell stack 12, where C, S and A are integers greater than zero. The battery cell stack 12 is arranged in an enclosure 50. The C cathode electrodes 20-1, 20-2, . . . , and 20-C include a cathode active material layer 24 on one or both sides of a cathode current collector 26. The A anode electrodes 40-1, 40-2, . . . , and 40-A include anode active material layers 42 arranged on one or both sides of the anode current collectors 46. The A anode electrodes 40 are manufactured to include LiₓSi/Si active material, amorphous carbon (C), and lithium fluoride (LiF) before formation as will be described further below.

During charging/discharging, the A anode electrodes 40 and the C cathode electrodes 20 exchange lithium ions. In some examples, the cathode active material layer 24 includes coatings including one or more active materials, one or more conductive additives, and/or one or more binder materials that are cast or applied to the current collectors.

In some examples, the cathode current collector 26 comprises metal foil, metal mesh, perforated metal, 3 dimensional (3D) metal foam, and/or expanded metal. In some examples, the cathode current collectors are made of one or more materials selected from a group consisting of stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

In some examples, the anode active material layer 42 of the A anode electrodes 40 includes silicon particles and PTFE binder. In some examples, the silicon particles have a diameter in a range from 1 μm to 10 μm. In some examples, the PTFE binder has a particle size in a range from 100 μm to 800 μm. In some examples, the PTFE binder has a particle size in a range from 300 μm to 700 μm. In some examples, the weight ratio of the PTFE binder to the composite anode electrode is in a range from 0.01:100 to 20:100 (e.g., 0.05:100). In some examples, the softening point of the PTFE is in a range from 270° C. to 380° C. The molecular weight of PTFE binder is in a range from 105 to 109 g/mol. In some examples, water is fully removed from the PTFE binder before use.

Referring now to FIGS. 2A to 2C, an idealized version of one of the A anode electrodes 40 includes the anode active material layer 44 and the anode current collector 46. The anode active material layer 44 includes a dry silicon film including anode active material 62 (e.g., silicon particles) and a binder 64 (e.g., a fibrillating binder such as PTFE). In FIG. 2B, the anode electrode 40 is shown after charging. The anode active material 62 swells and is alloyed with lithium at 66. In FIG. 20, the anode electrode 40 is shown after discharging and all of the lithium returns to the cathode electrode. However, in practice, some of the lithium is consumed by the silicon particles and the binder 64.

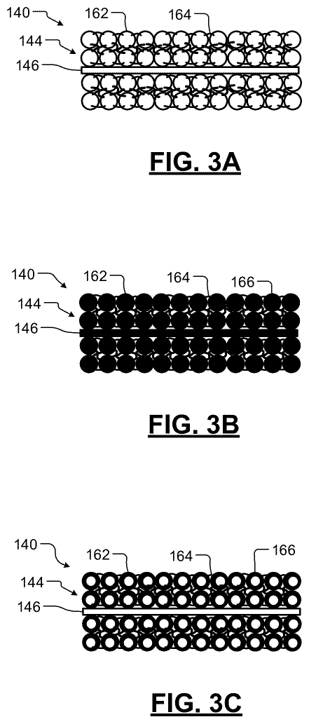

Referring now to FIGS. 3A to 3C, unlike the ideal anode electrode described in FIGS. 2A to 2C, some of the lithium is consumed by the silicon particles and the binder and remains in the anode electrode after discharging. An anode electrode 140 in FIG. 3A includes an anode active material layer 142 arranged on an anode current collector 146. The anode active material layer 144 includes anode active material 162 (e.g., silicon particles) mixed with a binder 164 (e.g., a fibrillating binder such as PTFE).

In FIG. 3B, the anode electrode 140 is shown after charging. The anode active material 162 swells and is alloyed with lithium at 166. In FIG. 3C, the anode electrode 140 is shown after discharging and some of the lithium returns to the cathode electrode and some of the lithium 166 is consumed by the silicon particles and the binder in the anode active material 162.

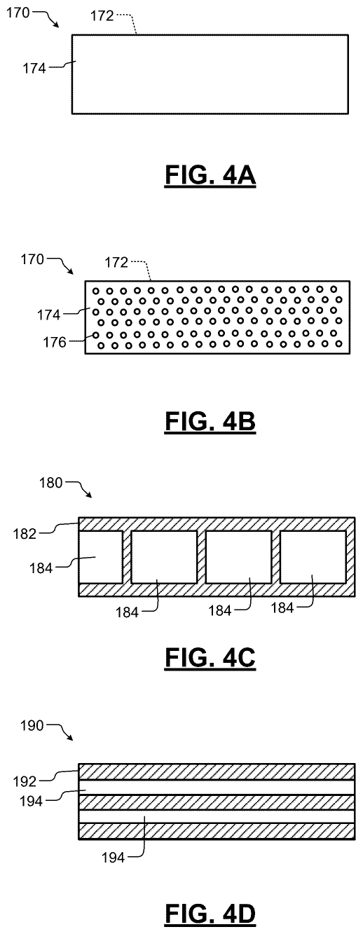

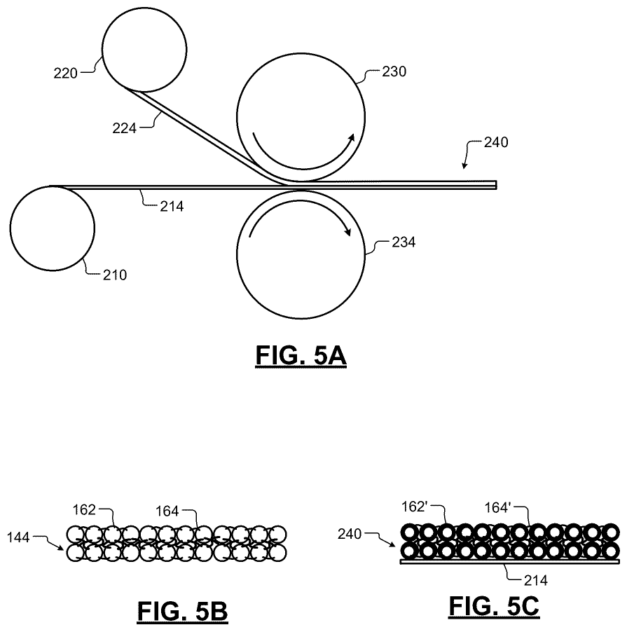

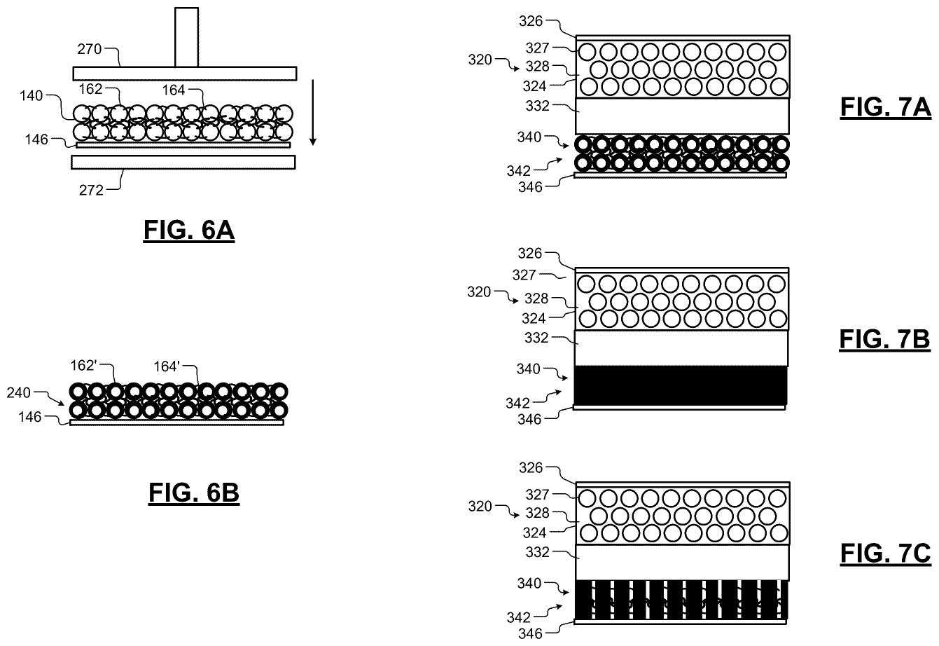

The anode electrode according to the present disclosure includes additional lithium to compensate for the lithium consumed by the binder and the silicon particles. Examples of the anode current collector that supplies excess lithium are shown in FIGS. 4A to 4D. Examples of manufacturing of the battery cell are shown and described in FIGS. 5A to 6B. Examples of a battery cell including the anode electrode are shown in FIGS. 7A to 7C.

Referring now to FIG. 4A to 4D, examples of anode current collectors that provide excess lithium to compensate for lithium consumption by the silicon particles and the binder are shown. In FIG. 4A, an anode current collector 170 includes a first material 172 such as copper foil and a second material 174 such as lithium foil arranged on one or both sides thereof.

In FIG. 4B, the anode current collector 170 is perforated and includes a pattern of spaced holes 178. In FIG. 4C, an anode current collector 180 includes a first material 182 such as copper foil and discrete portions 184 made of a second material such as lithium foil. In some examples, the first material 182 is a continuous material. In some examples, the discrete portions 184 of the second material have a length and width equal to the length and width of the anode electrodes.

In FIG. 4D, an anode current collector 190 includes a first material 192 such as copper foil and strips 194 made of a second material such as lithium foil. In some examples, the first material 192 and the strips 194 are continuous. In some examples, the strips 194 of the second material are spaced from one another in a widthwise direction. In some examples, the strips 194 of the second material stop and start (e.g., in a lengthwise direction similar to the discrete portions 184) and have a length equal to the length of the anode electrodes and a width less than the width of the anode electrode. In some examples, the strips 194 extend lengthwise in the direction of the roll. In other examples, the strips extend widthwise (e.g., transverse to the lengthwise in the direction of the roll). The strips 194 allow thicker and more commercially available lithium foil (e.g., 15 to 20 μm) to be used. The spacing between the strips 194 can be determined by the thickness of the lithium strips and the desired lithiation level.

In some examples, the anode active material layer includes active material in a range from 95 wt % to 99.9 wt % (e.g., including lithiated silicon and silicon) and binder in a range from 0.1 wt % to 5 wt % (e.g., including amorphous carbon and LiF). In some examples, loading of the anode electrode is in a range from 4 mAh/cm² to 30 mAh/cm². In some examples, a thickness of the anode electrode is in a range from 5 μm to 100 μm. The LiₓSi compensates for active lithium loss and provides good lithium-ion conduction within the anode electrode. The silicon particles provide high capacity and expand to form a compact anode electrode. The amorphous C and the LiF of the binder provide good electron pathways and enable uniform lithium flux. The binder also binds the silicon particles and lithiated silicon together.

In some examples, the electrolyte-free LiₓSi/Si anode electrode can be manufactured using a roll-to-roll process for continuous production or a flat press for discrete anode electrode production. A dry silicon film and an anode current collector including both lithium and copper foil are pressed together. The lithium of the anode current collector is directly pressed into one side of the active material layer. The lithium reacts with the PTFE and the silicon particles to form amorphous C and LiF and LiₓSi, respectively, which reduces the loss of active lithium in the battery cell.

In some examples, the lithium is used to fully react with PTFE and partially react with the silicon. In some examples, the lithium has a thickness in a range from 2 μm to 20 μm. In addition, the lithium is sticky which helps the dry silicon film to adhere to the copper foil. In some examples, the copper can be replaced by other electrochemically inactive metal, e.g., stainless steel, titanium, or other suitable materials.

Referring now to FIGS. 5A to 5C, a roll-to-roll process for manufacturing an anode electrode is shown. A roll 210 includes an anode current collector 214 that provides excess lithium. A roll 220 includes an anode active material layer 224 (e.g., a dry silicon layer) including a silicon anode active material and binder. The anode active material layer 224 and the anode current collector 214 pass through a pair of rollers 230 and 234 that press and/or heat the anode active material layer 224 and the anode current collector 214. In some examples, the rollers 230 and 234 apply pressure in a predetermined range (e.g., 15 to 30 MPa).

In FIG. 5B, the anode active material layer 144 includes a dry silicon film shown before pressing with the anode current collector 146. In FIG. 5C, the anode active material layer 144 is shown after pressing with the anode current collector 146. The excess lithium from the anode current collector 214 is consumed by the binder in the anode active material layer 224 and/or the silicon particles prior to formation of the battery cell, which reduces lithium loss from the cathode electrode.

Referring now to FIGS. 6A to 6B, a flat pressing method for manufacturing an anode electrode is shown. A press includes an upper plate 270 and a lower plate 272. The anode active material layer 144 (e.g., the dry silicon film) and the anode current collector 146 are arranged between the upper plate 270 and the lower plate 272. The upper plate 270 and the lower plate 272 apply pressure. The excess lithium from the anode current collector 146 is consumed by the binder and/or the silicon particles in the anode active material layer prior to formation of the battery cell, which reduces lithium loss from the cathode electrode.

After eliminating the side-reaction of PTFE/LiₓSi and increasing the active lithium within the battery cell, the advanced sulfide electrolyte-free LiₓSi/Si anode electrode forms a robust electrolyte-free LiₓSi lamination layer under battery cycling at high pressure (e.g., >50 MPa). Within the ASSB, the dense LiₓSi can provide a high lithium-ion conduction in the anode electrode.

Referring now to FIGS. 7A to 7C, a battery cell includes a cathode electrode 320, an anode electrode 340, and a separator 332. The cathode electrode 320 includes a cathode active material layer 324 (e.g., cathode active material 327 and a solid electrolyte 328) arranged on a cathode current collector 326. The anode electrode 340 includes an anode active material layer 342 arranged on an anode current collector 346 (and additional lithium to offset lithium consumed by the binder and/or silicon particles as described above). The separator 322 includes the solid electrolyte. Groups of the battery cells are pressed together (e.g., by rollers or a press) during manufacturing and pressed with high pressure when arranged in a battery cell enclosure and/or in battery modules.

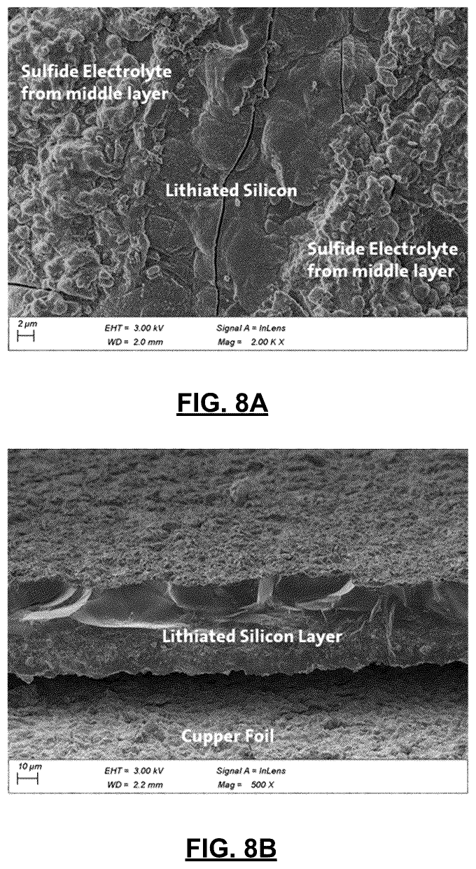

Referring now to FIGS. 8A and 8B, scanning electron microscope (SEM) images of the anode electrode is shown. The lithiated silicon anode merges into a dense lamination layer as can be seen in FIGS. 7B to 8B. Since this anode electrode design is electrolyte free, there is no sulfide electrolyte/silicon interface within the lithiated silicon anode electrode.

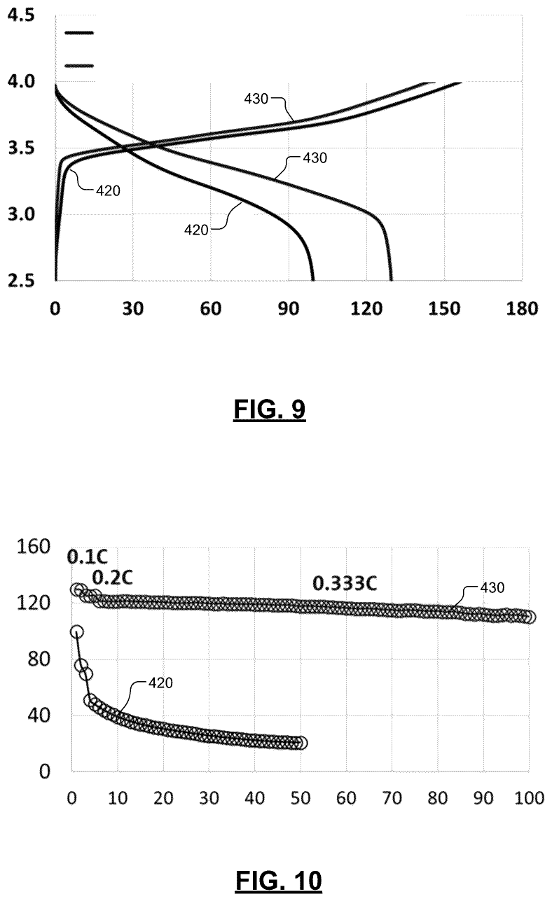

Referring now to FIGS. 9 and 10, electrochemical performance of the anode electrode is shown. In FIG. 9, voltage is shown as a function of capacity (for a first cycle at 0.1 C and room temperature) for a battery cell with a conventional anode electrode at 420 and an electrolyte-free lithiated silicon anode electrode at 430. In FIG. 10, capacity is shown as a function of cycles (at room temperature) for a battery cell with a conventional anode electrode and an electrolyte-free lithiated silicon anode electrode.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A method for manufacturing a battery cell comprising:
providing an anode active material layer including silicon particles and PTFE binder; and
pressing the anode active material layer and an anode current collector together to form an anode electrode,
wherein the anode current collector comprises a composite material comprising:
a first material; and
lithium arranged on at least one side of the first material and in contact with the anode active material layer.

2. The method of claim 1, wherein the first material is selected from a group consisting of copper, stainless steel, and titanium.

3. The method of claim 1, wherein the lithium formed on the at least one side of the anode current collector has the same dimensions as the first material.

4. The method of claim 1, wherein the composite material includes holes.

5. The method of claim 1, wherein the lithium formed on the at least one side of the anode current collector includes a plurality of lithium portions that are spaced from one another.

6. The method of claim 5, wherein the plurality of lithium portions have a length and width corresponding to a length and width of the anode electrode.

7. The method of claim 1, wherein the lithium formed on the at least one side of the anode current collector includes a plurality of strips that are spaced from one another.

8. The method of claim 1, wherein the anode active material layer includes the anode active material in a range from 95 wt % to 99.9 wt % and the binder in a range from 0.1 wt % to 5 wt %.

9. The method of claim 1, wherein:
a thickness of the anode electrode is in a range from 5 μm to 100 μm,
a thickness of the lithium is in a range from 2 μm to 20 μm, and
the silicon particles have a diameter in a range from 1 μm to 10 μm.

10. The method of claim 1, wherein:
the PTFE binder has a particle size in a range from 100 μm to 800 μm, and
a weight ratio of the PTFE binder to the anode electrode is in a range from 0.01:100 to 20:100.

11. An anode electrode for manufacturing a battery cell comprising:
an anode active material layer including silicon particles and PTFE binder;
an anode current collector comprising a composite material including:
a first material; and
lithium arranged on at least one side of the first material and in contact with the anode active material layer,
wherein the lithium reacts with the anode active material layer to form amorphous carbon, lithium fluoride, and LiₓSi in the active material layer prior to formation.

12. The anode electrode of claim 11, wherein the first material is selected from a group consisting of copper, stainless steel, and titanium.

13. The anode electrode of claim 11, wherein the lithium arranged on the at least one side of the anode current collector has the same dimensions as the first material.

14. The anode electrode of claim 11, wherein the anode current collector includes holes.

15. The anode electrode of claim 11, wherein the lithium formed on the at least one side of the anode current collector includes a plurality of lithium portions that are spaced from one another.

16. The anode electrode of claim 15, wherein the plurality of lithium portions have a length and width corresponding to a length and width of the anode electrode.

17. The anode electrode of claim 11, wherein the lithium formed on the at least one side of the anode current collector includes a plurality of strips that are spaced from one another.

18. The anode electrode of claim 11, wherein the anode active material layer includes the anode active material in a range from 95 wt % to 99.9 wt % and the binder in a range from 0.1 wt % to 5 wt %.

19. The anode electrode of claim 11, wherein:
a thickness of the anode electrode is in a range from 5 μm to 100 μm,
a thickness of the lithium is in a range from 2 μm to 20 μm, and
the silicon particles have a diameter in a range from 1 μm to 10 μm.

20. The anode electrode of claim 11, wherein:
the PTFE binder has a particle size in a range from 100 μm to 800 μm, and
a weight ratio of the PTFE binder to the anode electrode is in a range from 0.01:100 to 20:100.
